(19) United States
(12) Patent Application Publication
(10) Pub. No.: US 2005/0224338 A1
(43) Pub. Date: Oct. 13, 2005

(54) Water treatment reactor for simultaneous electrocoagulation and advanced oxidation processes

(75) Inventors: Kon-Tsu Kin, Hsinchu (TW); Hong-Shiang Tang, Hsinchu (TW); Shu-Fei Chan, Hsinchu (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 10/820,020

(22) Filed: Apr. 8, 2004

(51) Int. Cl. C02F 1/46

(52) U.S. Cl. 204/230.2

(57) ABSTRACT

A water treatment reactor adapted to simultaneously carry out electrocoagulation and advanced oxidation processes is disclosed, which includes an upright sealed tank having a metal body, or a metal mounted on an inner wall thereof, used as a cathode; a sacrificial electrode used as an anode, which is disposed in the tank and non-electrically connected to the cathode; a mixing device disposed in the bottom of the tank for enabling mixing of influent water and an air or oxygen-containing gas introduced into the tank; a gas-liquid separator which is in fluid communication with the tank at the top for expelling a gas from the tank without expelling water; and a direct current supply having a positive electrode electrically connected to the anode and a negative electrode electrically connected to the cathode.

### BACKGROUND OF THE INVENTION

1. Field of the Invention

The present invention relates to a water processing apparatus, and more particularly, to a water treatment reactor for simultaneously processing wastewater containing organic contaminants, suspended particulates and ionic materials.

2. Description of the Related Art

With advances in semiconductor manufacturing processes, the composition of wastewater produced by the semiconductor industry has become increasingly complex, and this has led to greater difficulties in wastewater treatment and recycling. For example, wastewater generated by chemical mechanical polishing processes includes not just abrasive particulates, but also organic dispersants, copper, arsenic. Additionally, the cleaning process after the polishing process generates surfactants and fluorine ions. Past efforts to achieve coalescence of contaminants in effluent streams without the use of added chemicals have met with some success, but have also had problems with efficiency, cost, flexibility and disposal of the coalesced materials. In addition, many systems require batch processing rather than continuous processing.

The design of an apparatus for electrocoagulation of liquids is often limited to the processing of indissolvable particles and materials in water. For example, U.S. Pat. No. 6,139,710 discloses a housing defining a reaction chamber, and a plurality of spaced reaction plates/blades that are oriented in a vertical position within the reaction chamber, which keep the waste stream from plugging a flow path. U.S. Pat. No. 6,238,546B1 discloses a similar design; the apparatus utilizes a sealed design with a gas valve for an outlet. Another method exists that utilizes an advanced oxidation processes, or an electrical oxidation processes, to perform a water recycling process, particularly for organic wastewater such as UV-O₃, Fenton, and H₂O₂-Catalyst. For example, U.S. Pat. No. 5,817,240 discloses a reactor for an advanced oxidation process, which employs hydrogen peroxide for the degradation of contaminants in an aqueous medium. Specifically, the process increases, and preferably maximizes, the availability of usable reactive intermediates (hydroxyl radicals) derived from the hydrogen peroxide interaction with a catalyst by controlling the exposure time of the hydrogen peroxide with the catalyst.

The assignee of this application in U.S. patent application Ser. No. 10/310,875, filed Dec. 6, 2002, discloses a process and an apparatus for removing deep sub-micron particles from water. This prior art process includes adjusting pH value and conductivity, adding an oxidation agent, performing an electrocoagulation reaction/an electro-oxidation reaction, and performing a flocculation sedimentation, etc. This prior art apparatus includes a front adjustment tank for adjusting the properties of waste water, wherein the adjustment includes a pH adjustment, an electrolyte adjustment, or an oxidant addition, etc.; an electrocoagulation reaction tank receiving water from the front adjustment tank and having pairs of separated electrodes, one of the electrodes being made of iron; a rear adjustment tank for adjusting pH value of the effluent of the electrocoagulation reaction tank; and a sedimentation reservoir for providing the resulting pH-adjusted, sedimentary floccule-containing water from the rear adjustment tank with a sufficient residence time in said sedimentation reservoir, so that floccules and sedimentation are formed therein. Details of the invention disclosed in this U.S. patent application Ser. No. 10/310875 is incorporated herein by reference.

It is desirable, however, to provide a water treatment reactor adapted to simultaneously carry our electrocoagulation and advanced oxidation processes to mitigate and/or obviate the aforementioned problems.

### SUMMARY OF THE INVENTION

A main objective of the present invention is to provide a reactor design which is adapted to simultaneously carry out electrocoagulation and advanced oxidation processes. Therefore, the reactor of the present invention can simultaneously treat wastewater containing organic contaminants, suspended particulates and ionic materials. The present invention can be utilized in TFT-LCD optoelectronic industries, semiconductor manufacturing and packaging industries, circuit board manufacturing industries and other related industries.

A water treatment reactor for simultaneous electrocoagulation and advanced oxidation processes comprising:
an upright sealed tank, the upright sealed tank having a metal body, or a metallic material mounted on an inner wall thereof, for use as a cathode;
a sacrificial electrode used as an anode which is disposed in the tank and non-electrically connected to the cathode;
an intake tube for introducing influent water into the button of the tank;
an air input for introducing air or oxygen-containing gas into the tank;
a mixing device disposed in the bottom of the tank for enabling mixing of the influent water;
an outlet tube for venting processed water from a top of the tank;
a gas-liquid separator which is in fluid communication with the tank at the top of the tank for expelling a gas from the tank without water expelling; and
a direct current supply having a positive electrode electrically connected to the anode and a negative electrode electrically connected to the cathode.

Preferably, the reactor of the present invention further includes an oxidant supply device mounted on the intake tube, and the oxidant supply device includes a venturi in fluid communication with the intake tube.

Preferably, the sacrificial electrode is made of iron, aluminum, copper or stainless steel.

Preferably, the reactor is made of stainless steel.

Preferably, the mixing device further comprises a spiral board, a packing material or a perforated dish.

Preferably, the gas-liquid separator further comprises a gas-liquid separating valve.

The reactor of the present invention first performs an oxidation process, and then an electrocoagulation process. The reactor removes organic material in the water with the oxidation process, and also works to remove suspended particles with the following electrocoagulation process. This resolves steric stabilization and depletion stabilization problems caused by surface bonding between the organic materials and the particles, and therefore improves the quality of the electrocoagulation process.

Other objects, advantages, and novel features of the invention will become more apparent from the following detailed description when taken in conjunction with the accompanying drawings.

### BRIEF DESCRIPTION OF THE DRAWINGS

FIG. 1A is a cross-sectional drawing of a multi-reactor for electrocoagulation/advanced oxidation processes (AOPs) according to the present invention.

FIG. 1B is a schematic drawing of an upper spiral cover depicted in FIG. 1A.

FIG. 1C is a schematic drawing of a support depicted in FIG. 1A.

FIG. ID is a schematic drawing of a perforated dish depicted in FIG. 1A.

FIG. 1E is a schematic drawing of a lower spiral cover depicted in FIG. 1A.

### DETAILED DESCRIPTION OF THE PREFERRED EMBODIMENT

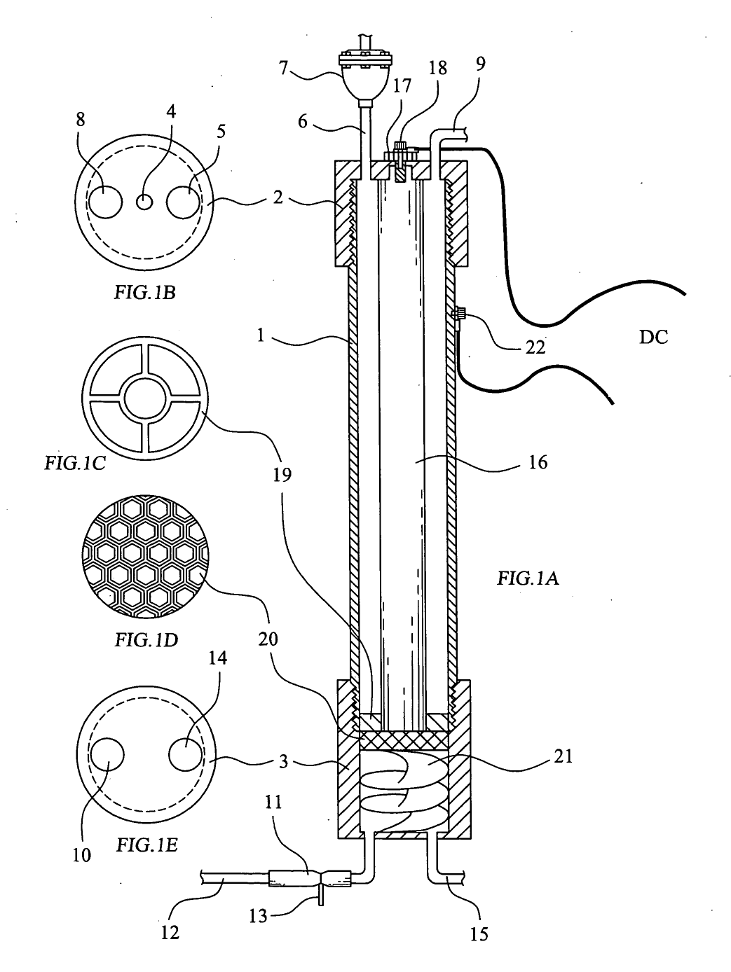

Please refer to FIGS. 1A to 1E. The present invention discloses a multi-reactor for electrocoagulation/advanced oxidation processes (AOPs). The reactor comprises a cylindrical stainless steel tank 1; the tank 1 has two spiral covers 2, 3, made of a PE material, which are separately disposed on upper and lower ends of the tank 1 to form a sealed chamber with the tank 1. The tank 1 has a screw 22 used for connecting to a negative electrode (−) of an external DC power source.

The upper spiral cover 2 has three differently sized apertures 4, 5, 8. The aperture 4 is used to fix an anode and connecting to a positive electrode (+) of the external DC power source. The aperture 5 is connected to an exhaust tube 6; an upper section of the exhaust tube 6 is connected to a gas-liquid separating valve 7, which vents only gas to prevent the outflowing of water from the tank 1. The aperture 8 is connected to a tube 9, and is used for passing the processed water into a following flocculation separation unit (such as a pH adjusting unit, a sedimentation unit or a filtering unit).

The lower spiral cover 3 has two differently sized apertures 10, 14. The aperture 10 connects to an intake tube 12 for passing influent water into the tank 1. A venturi tube 11 is placed at the intake tube 12 and further connected to an oxidant supply line 13 for providing a chemical reagent for electrical oxidation; the chemical reagent may be H₂O₂₍₁₎, Cl⁻₍₁₎ or O_{3(g)}. The aperture 14 connects to an air input 15; the air input 15 provides air into the chamber to improve dissolved oxygen in water, increase turbulence in the water, raise the surface contact rate between the water and the anode, and helps in the formation of electrocoagulation/floculation.

A metal electrode 16 is placed in a central position of the tank 1, and may be composed of iron, aluminum or stainless steel. An upper end of the electrode 16 is mounted on the upper spiral cover by way of a screw 17 through the hole 4. A small screw 18 on the screw 17 is connected to the positive electrode (+) of the external DC power source. An anode support 19 is mounted on the button of the tank, which fixes the electrode 16 in the central position. A perforated dish 20 is placed below the anode support 19 for evenly distributing the air provided by the input 15. Furthermore, a spiral board 21 is placed below the perforated dish 20 for mixing the oxide, the influent water and the air.

### First Embodiment

### A Semiconductor Chemical Mechanical Polishing Wastewater Treatment Processor

In this embodiment, wastewater from a semiconductor factory is used by way of example; the composition of the wastewater is indicated in the following Table 1.

TABLE 1

| Water quality items | Value |
|---|---|
| pH | 4.5 |
| Electrical conductivity | 36 |
| (μS/cm) | |
| Suspended solid (SS) (%) | 0.02 |
| Turbidity (NTU) | 25 |
| Total organic carbon (TOC) | 3754 |
| (ppb) | |
| Silicates (ppm) | 282 |
| Copper ions (ppm) | 10 |

The anode selected in this embodiment was made of iron, and the oxidant was H₂O₂, which provided an electrical oxidation reaction process in combination with the electrocoagulation process created in the reactor. Before ferrous ions released from the anode was converted into ionic iron, theferrous ions reacted with the H₂O₂ to generate .OH. After the electrical oxidation reaction, ferrous ions were converted into ionic iron, and was then used in the electrocoagulation process to generate a floculation of iron hydroxide that caught fine particulates in the water. Therefore, by appropriate adjusting of the operating conditions, such as the current/voltage, pH, oxidant input and mixing, aeration etc., both the electrocoagulation and advanced oxidation processes may be simultaneously carried out.

Detailed operating conditions and results of this embodiment are shown in Table 2. In this embodiment, the pH value of the influent water was adjusted to 9.3, and the water was then sent into the reactor. The influent water flowed through the venturi tube 11 and absorbed H₂O₂ from the oxidant supply line 13, being finally mixed at the spiral board 21 at the button of the tank 1. The concentration of the mixed influent water was 120 ppm. Simultaneously, the air input 15 injected 2L/min air under pressure. Both the air and the water were evenly distributed after passing through the perforated dish 20, which also helped the fluid in the tank to generate turbulence so that the influent water quickly contacted the anode surface. The tank 1 of the reactor was connected to the negative electrode (−) of an external DC power source; the iron electrode 16 was placed in the center of the tank and connected to the positive electrode (+) of the external DC power source. Electrical power at 50 volts and 1 ampere was then provided by the power source. The hydraulic retention time of the influent water was 10 minutes. hydrogen and oxygen generated from the electrocoagulation processes was mixed with the air introduced by the air input 15 and vented from the gas-liquid separating valve 7 to avoid explosions. The processed water was then vented from the tube 9, and its pH value was adjusted to 5.8. An external sedimentation unit was then employed to provide the hydraulic retention time to enable the processed water to sediment floculation. Afterwards, the processed water could be recycled.

TABLE 2

| | | Water quality | | | |
|---|---|---|---|---|---|
| | | | Before | After | Removal |
| Operating condition | | Item | treatment | treatment | ratio |
| Current | 1 A | | | | |
| Voltage | 50 V | pH | 4.5 | 6.4 | — |
| H₂O₂ | 120 ppm | Electrical | 36 | 53 | — |
| addition | | conductivity | | | |
| | | (μS/cm) | | | |
| Hydraulic | 10 min | SS (%) | 0.02 | 0.001 | 95% |
| retention | | | | | |
| time | | | | | |
| Aeration | 2 L/min | Turbidity | 25 | 0.6 | 97.6% |
| | | (NTU) | | | |
| Influent | 5.8 | TOC (ppb) | 3754 | 301 | 92% |
| pH | | | | | |
| adjustment | | | | | |
| Effluent | 9.3 | Silicates | 282 | 12 | 96% |
| pH | | (ppm) | | | |
| adjustment | | | | | |
| Sedimen- | 10 min | Copper ion | 10 | 0.08 | 99.2% |
| tation | | (ppm) | | | |
| time | | | | | |

As indicated in Table 2, under the correct operating conditions, the multi-reactor for electrocoagulation/advanced oxidation processes can remove organic contaminants, suspended particulates, dissolvable silicic acid saline and copper ion with a removal ratio exceeding 90%.

### Second Embodiment

### Heavy Muddy Underground Water Purification Process

In this embodiment, underground water removed from an industrial location is used as an example. The reactor of the present invention can purify underground water to replace industry tap-water.

This processes and operating conditions of this embodiment are the same as those in the first embodiment. Removal ratios, and changes in composition, are shown in Table 3.

TABLE 3

| | | Water Quality | | | |
|---|---|---|---|---|---|
| | | | Before | After | |
| | | | treat- | treat- | Removal |
| Operating condition | | Item | ment | ment | ratio |
| Current | 1 A | | | | |
| Voltage | 50 V | PH value | 6.7 | 6.3 | — |
| H₂O₂ addition | 60 ppm | Electric | 641 | 647 | — |
| | | Conductivity | | | |
| | | (μS/cm) | | | |
| Hydraulic | 10 min | Turbidity | 58.4 | 0.9 | 98.5% |
| retention time | | (NTU) | | | |
| Aeration | 2 L/min | Iron (ppm) | 2.15 | 0.4 | 81.4 |
| Influent pH | 5.8 | silicates (ppm) | 38 | 8 | 78.9 |
| adjustment | | | | | |
| Effluent pH | 9.3 | | | | |
| adjustment | | | | | |
| Sedimentation | 5 min | | | | |
| time | | | | | |

According to Table 3, under the proper operating conditions, the multi-reactor for electrocoagulation/advanced oxidation processes can also reduce Turbidity, iron ion and dissolvable silicates. During the reaction process, the electrical oxidation reaction converts iron ions and silicates in the underground water into oxidative particles, which are caught in the further electrocoagulation process.

Although the present invention has been explained in relation to its preferred embodiment, it is to be understood that many other possible modifications and variations can be made without departing from the spirit and scope of the invention as hereinafter claimed.

1. A water treatment reactor for simultaneous electrocoagulation and advanced oxidation processes comprising:
an upright sealed tank, the upright sealed tank having a metal body, or a metallic material mounted on an inner wall thereof, for use as a cathode;
a sacrificial electrode used as an anode which is disposed in the tank and non-electrically connected to the cathode;
an intake tube for introducing influent water into the button of the tank;
an air input for introducing air or oxygen-containing gas into the tank;
a mixing device disposed in the bottom of the tank for enabling mixing of the influent water;
an outlet tube for venting processed water from a top of the tank;
a gas-liquid separator which is in fluid communication with the tank at the top of the tank for expelling a gas from the tank without water expelling; and
a direct current supply having a positive electrode electrically connected to the anode and a negative electrode electrically connected to the cathode.

2. The reactor as claimed in claim 1 further comprising an oxidant supply device mounted on the intake tube.

3. The reactor as claimed in claim 2, wherein the oxidant supply device includes a venturi in fluid communication with the intake tube.

4. The reactor as claimed in claim 1, wherein the sacrificial electrode is made of iron, aluminum, copper or stainless steel.

5. The reactor as claimed in claim 4, wherein the sacrificial electrode is made of iron.

6. The reactor as claimed in claim 1, wherein the reactor is made of stainless steel.

7. The reactor as claimed in claim 1, wherein the mixing device further comprises a spiral board, a packing material or a perforated dish.

8. The reactor as claimed in claim 1, wherein the gas-liquid separator further comprises a gas-liquid separating valve.
